(19) United States
(12) Patent Application Publication
(10) Pub. No.: US 2021/0355858 A1
(43) Pub. Date: Nov. 18, 2021

(54) Ignition Piston 2

(71) Applicant: Victor Rudolph Bloomquist, Brush Prairie, WA (US)

(72) Inventor: Victor Rudolph Bloomquist, Brush Prairie, WA (US)

(21) Appl. No.: 17/300,101

(22) Filed: Mar. 10, 2021

Related U.S. Application Data
(63) Continuation-in-part of application No. 16/873,251, filed on Mar. 6, 2020, now abandoned.

(51) Int. Cl. F02B 3/08; F02B 23/04

(52) U.S. Cl. CPC F02B 3/08; F02B 23/04

(57) ABSTRACT

This engine is different from all other engines; because it can burn a leaner air fuel mixture than any other engine.

It is an internal combustion engine using two pistons operating in two different cylinders; the cylinders are parallel; the cylinders are adjacent to each other; one cylinder is smaller than the other; the smaller piston is operating in the smaller cylinder I3 and it is the ignition piston I; the larger piston 2 is operating in the larger cylinder I4; both pistons are operated by the same crankshaft I7; the crankshaft I7 has the two conrod journals I5 and I6 side by side sixteen degrees apart; the smaller ignition piston crankshaft conrod journal I5 is eight degrees before top dead center (TDC); the larger piston crankshaft conrod journal I6 is eight degrees after TDC; at this rotational position of the crankshaft I7 the smaller ignition piston I is compressing the air fuel mixture to combustion; at combustion, the pressure in the small piston combustion chamber IO opens relief valve 3 in the head II; the relief valve 3 opens channel 8 in the head II between the small piston I and the larger low compression piston combustion chamber 9; the high pressured burning air fuel mixture is forced into the lower pressure large piston combustion chamber 9; thus igniting the air fuel mixture in the large piston combustion chamber 9.

My new design on the small piston conrod I8 puts the torque past the TDC of the crankshaft I7 when the crankshaft conrod journal I5 is eight degrees befor TDC; the down thrust of conrod I8 has no support except for thrust rod 26; thrust rod 26 uses pins to mount it to conrod I8; thrust rod hole 25 is connected to conrod hole 22 by a pin and hole 24 is connected to hole 23 by a pin thus mounting the thrust rod 26 to the conrod I8; conrod I8 has no vertical support on the bottom end because space 2I is just open space; because conrod I8 has no down motion support except thrust rod 26; thrust rod 26 receives the piston thrust; thrust rod 26 puts the thrust on to pin hole 23 of receptacle I9 past TDC.

The relief valve I thought of has a main shaft 7; one end of shaft 7 is the seal area between the combustion chamber IO and the ignition channel 8; piston 4 is securely attached to shaft 7; piston 4 has compression rings and an oil ring; area 5 is where the pressure adjusting spring is compressed between piston 4 and adjusting cylinder 6; adjusting cylinder 6 is adjusted by a bolt or operated by a cam shaft.

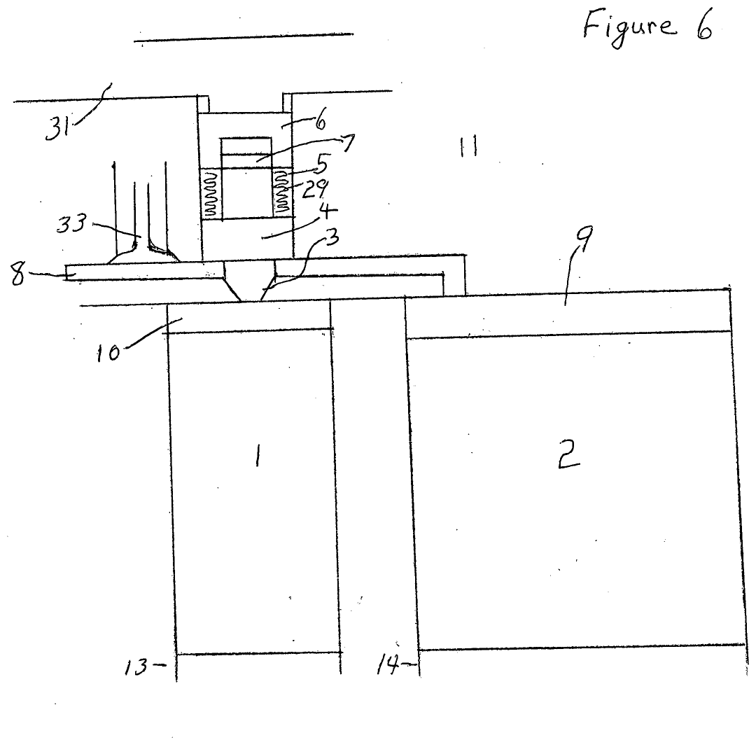

In addition another optional use of my relief valve, with added parts, is the timing of the combustion on the ignition piston. Figure five shows a camshaft 3I which relieves pressure on the relief valve pressure adjusting cylinder 6 when the cam side is up; this releasing the pressure on spring 29 this allowing the air fuel mixture to escape into channel 8 in the first part of the compression stroke of the ignition piston I; then the cam 32 comes around and pushes adjusting cylinder 6 down compressing spring 29 closing the valve 3; the closing of valve 3 is done when there is just the fight amount of volume of the fuel air mixture in the combustion chamber IO; this is done so that when the ignition piston I reaches TDC, or a little befor, it has combustion pressure and not befor; thus preventing combustion pressure too early in the compression stroke and preventing precombustion. The timing relief valves would not be needed if the ignition piston stroke did not compress the air fuel mixture to combustion befor TDC. Another way of using the relief valve to time the engine is; just air with no fuel sucked into chamber I0 on the intake stroke; then compressing the air to high combustion heat on the compression stroke; then have a controlled timing opening of the relief valve 3; this letting high pressure high combustion heated air into channel 8; channel 8 being filled with fuel air mixture received through intake valve 33; this hot air igniting the fuel air mixture; this explosion of fire goes into chamber I0 and chamber 9 driving both piston I and igniting the air fuel mixture in chamber 9; a drawing of this timing is FIG. 6.

### NUMBERS AND NAMES OF PARTS

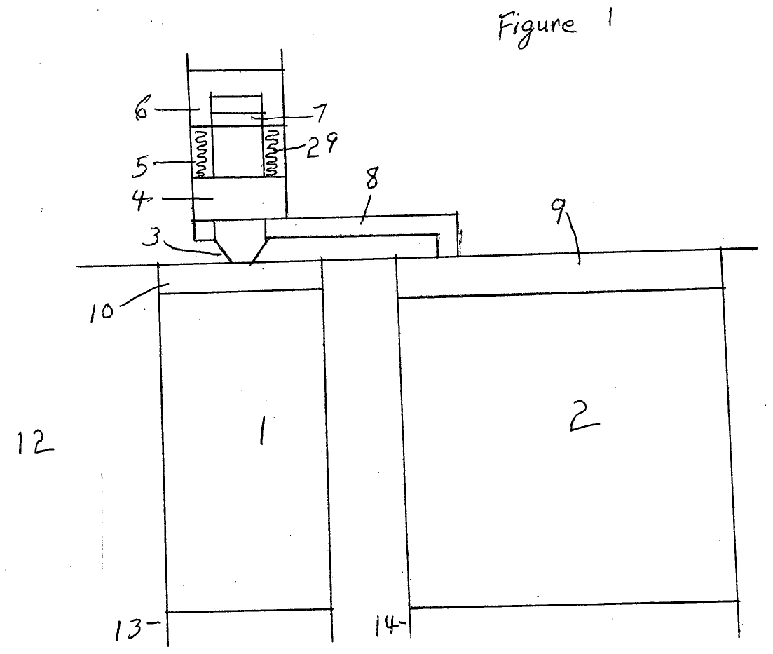

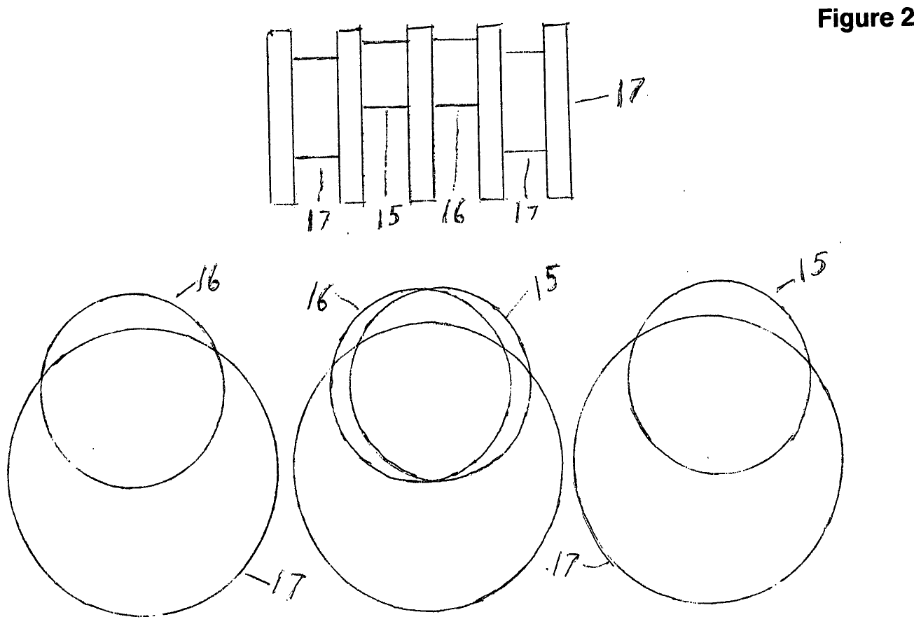

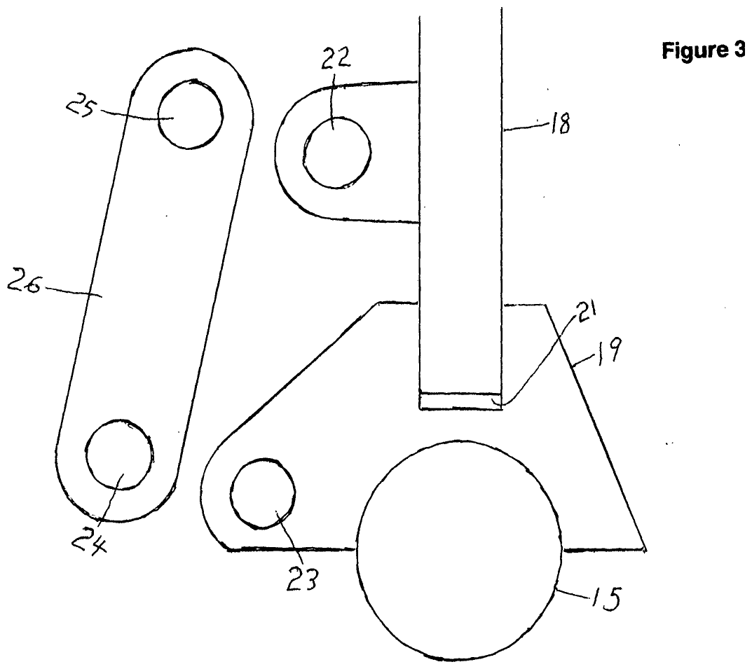

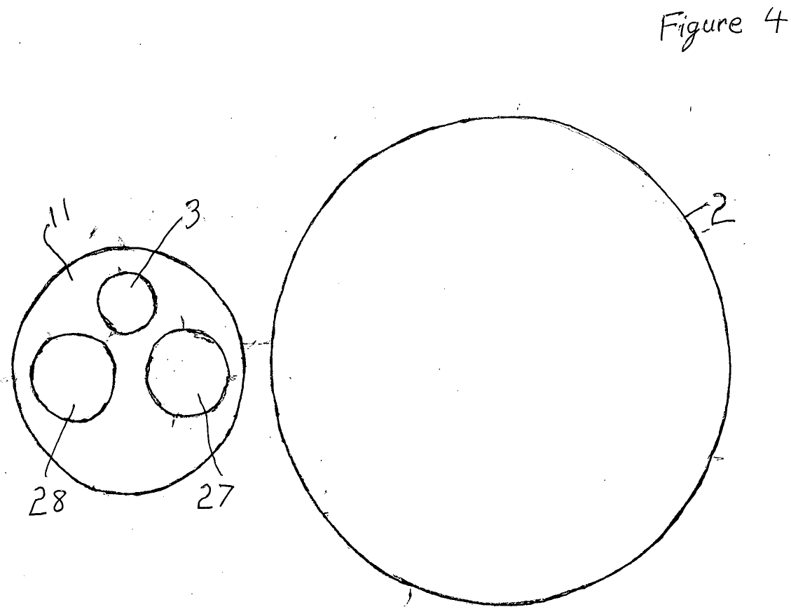

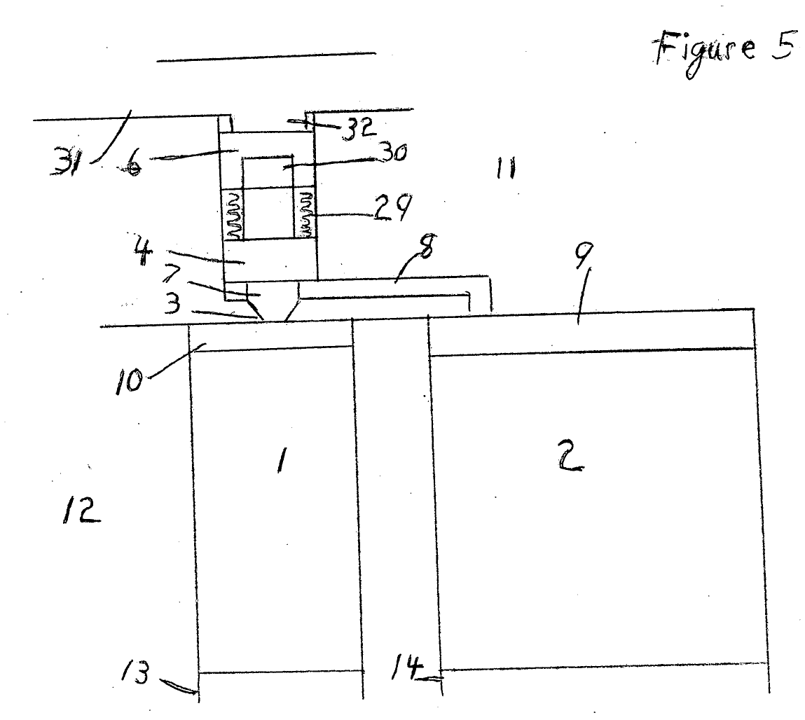

FIG. I:
   I ignition piston
   2 larger piston
   3 relief valve
   4 relief valve piston
   5 relief valve pressure spring compartment
   6 relief valve pressure adjusting cylinder
   7 relief valve main shaft
   8 ignition fire channel
   9 large piston combustion chamber
   I0 ignition piston combustion chamber
   II engine head
   I2 engine block
   I3 ignition piston cylinder
   I4 larger piston cylinder
FIG. 2
   I5 ignition piston crankshaft conrod journal
   I6 larger piston crankshaft conrod journal
   I7 total crankshaft
FIG. 3:
   I8 ignition piston conrod
   I9 receptacle for the conrod and thrust rod
   2I empty space under the lower end of the conrod
   22 conrod thrust rod receptacle pinhole
   23 crankshaft mounted receptacle pinhole for the thrust rod
   24 lower connecting pinhole in the thrust rod
   25 upper connecting pinhole in the thrust rod
   26 thrust rod
FIG. 4:
   27 ignition piston intake valve
   28 ignition piston exhaust valve
FIG. 5:
   3 relief timing valve
   29 relief timing valve compression spring
   6 relief timing valve pressure adjusting cylinder
   30 airspace
   3I timing camshaft
   32 the protrusion or cam part of the camshaft
FIG. 6:
   33 intake valve for channel 8

I. Because ignition is accomplished by compression there is no spark plug electrical system or a high pressure injector system.

2. A new design conrod for the high compression ignition piston; it puts the piston push torque past top dead center even when the conrod crankshaft journal is before top dead center.
